(19) United States
(12) Patent Application Publication
(10) Pub. No.: US 2023/0385457 A1
(43) Pub. Date: Nov. 30, 2023

(54) Method for Ensuring Transparency of Data Provenance in a Data Processing Chain

(71) Applicant: Bayerische Motoren Werke Aktiengesellschaft, Muenchen (DE)

(72) Inventors: Adnan BEKAN, Muenchen (DE); Carsten STOECKER, Dortmund (DE); Daniel WILMS, Las Palmas de Gran Canaria (ES)

(21) Appl. No.: 18/034,121

(22) PCT Filed: Nov. 27, 2020
(86) PCT No.: PCT/EP2020/083754

§ 371 Date: Apr. 27, 2023

(51) Int. Cl. G06F 21/64

(52) U.S. Cl. CPC G06F 21/64

(57) ABSTRACT

Methods, systems, and devices for ensuring transparency of data provenance in a data processing chain are provided. A data processing chain includes a plurality of processing components. Each of the plurality of processing components is configured to process source data to generate result data. A globally unique data identifier is assigned to each of the processing components. In response to a processing component processing source data, result data is transmitted to a data manager. The result data includes information about a globally unique identifier assigned to the processing component and information about the source data.

### BACKGROUND AND SUMMARY OF THE INVENTION

The present subject matter relates to a method for ensuring transparency of data provenance in a data processing chain, an electronic control unit, a vehicle comprising such an electronic control unit, and a data processing chain.

Big data processing and analytics are a more and more important aspect of modern computing. Organizations are relying on insights derived from big data to aid in decision making, identify cost reduction opportunities, etc. Therein, based on the growing use of data producing and/or Internet of Things (IoT) devices, there is a trend toward processing open data.

For example, with almost every new vehicle being connected, the importance of vehicle data is growing rapidly. Therein, many mobility applications rely on the fusion of data coming from heterogeneous data sources, for example vehicles and data transmitted to the vehicles from outside of the vehicle, for example smart-city data, or process data generated by systems out of their control. This external data determines much about the behavior of the relying applications. For example, it impacts the reliability, security and overall quality of the data inputted into an application and ultimately of the application itself.

The secure traceability of data handling along an entire processing chain, which passes through various distinct systems, is, however, critical for the detection and avoidance of misuse and manipulation. Therefore, there is a need for ensuring the validity of source data inputted into such an application and also to ensure the accuracy of the data outputted by the application. Upcoming regulations around cyber-security underline this importance.

The document US 2018/0129712 A1 discloses a method, wherein a data identifier correlator generates a source data ID in response to a request from a processing component to access source data, wherein the source data is transmitted in association with the source data ID to the processing component. The processing component processes the source data to generate result data, wherein a process ID correlator generates a process ID, transmits the result data in association with the process ID and the source data ID to a streaming manager, and transmits the process ID in association with the processing component ID to the streaming manager. The streaming manager is linking the association of the result data with the process ID and the source data ID with the association of the processing component ID with the process ID.

According to one example of the present subject matter, a method for ensuring transparency of data provenance in a data processing chain is provided, wherein the data processing chain comprises a plurality of processing components, wherein each of the plurality of processing components is configured to process source data to generate result data. Therein, a globally unique identifier is assigned to each of the plurality of processing components, wherein, in response to a processing component of the plurality of processing components processing source data, the corresponding result data is transmitted to a data manager, wherein transmitting the corresponding result data to the data manager comprises transmitting information about a globally unique identifier assigned to the processing component and about the source data to the data manager.

A data processing chain is a sequence of processes that generate an instruction, for example an instruction for an electronic component, based on a given source data, wherein the data is successively processed by the sequence of processes. A data processing chain consists of a start process, individual application processes and a collection process. Further, the sequence of processes are scheduled to wait in the background for an event, wherein some of these processes trigger a separate event that can, in turn, start other processes.

An example of such a data processing chain is a data processing flow in automotive contexts. Such a data processing flow starts with a data producer, typically an electronic control unit, which transports a signal over a system bus. The signal is received and edge-processed within the vehicle by a data collector, typically another electronic control unit. The first pre-processing of the signal, for example adding meta data information or doing some pre-calculation, will be done here, before it will be transported to a further electronic control unit, a digital representation, which defines the incoming data of the physical vehicle through a digital model, and offers it to applications as a digital shadow or even a digital twin of the vehicle. From there, an optional data fusion with data from external data sources is possible, wherein the data is then consumed by data processors, respectively electronic control units, which in turn create new data of interest for example for an external data consumer.

Therein, the processing components are the components responsible for the processing of the data, wherein each process of the data processing chain is carried out by a separate processing component. Each processing component processes input data, the respective source data, to generate result data. An example of such a processing component is an electronic control unit of a vehicle. The source data can be collected by the processing component itself and/or received from one or more data managers.

A data manager is a component that stores result data and distributes the result data as source data to other processing components, wherein a separate data manager can be assigned to each processing component. Such a data manager can for example be integrated in a BE-system, respectively an apparatus implementing a digital twin of a physical system, for example a vehicle, or a further processing component that is configured to subsequently process the result data.

Further, a globally unique identifier is a unique identification, usually a number that is assigned to a processing component, wherein the globally unique identifier is used to identify the respective processing component, wherein the globally unique identifier does not duplicate an identifier that has already been, or will be, created to identify something else anywhere. For example, decentralized identifiers can be used as globally unique identifiers.

Furthermore, data provenance is metadata that is paired with records that details the origin, changes to, and details supporting the confidence or validity of data.

Therein, the information about a globally unique identifier assigned to the processing component and about the source data can for example comprise a link to the processing component and a link to the source data.

Thus, a method is provided, with which the provenance of source data inputted in a processing component of the data processing chain is made transparent and can be understood. A mechanism for establishing secure data provenance in real time at the hardware level is provided, wherein it is indicated which entity, respectively which processing component has generated the result data. This data provenance can then be used to ensure the validity of source data inputted into a processing component and also to ensure the accuracy of the data outputted by a processing component, and, in particular, for the detection and avoidance of misuse and manipulation. Therein, the information about a globally unique identifier assigned to the processing component and about the source data is preferably encrypted.

That a globally unique identifier is assigned to each processing component has the advantage that also data provided by external data sources, which can also be regarded as processing components within the data processing chain, can, usually after a corresponding trust verification, be provided and processed within the data processing chain, wherein also the provenance of the externally provided data is transparent and can be understood.

The method can also comprise the steps of validating integrity of the data processing chain based on the transmitted information about the globally unique identifier assigned to the processing component and the source data, and, if it is determined that the data processing chain has a low integrity, performing a safety-relevant action.

Here, that the data processing chain has a low integrity means that there seem to be some risks in processing the data or that the instruction generated by the data processing chain, or that the result data generated by one or more processing components does not seem to be correct or rational, based on a given source data.

Further, a safety-relevant action is an action that is taken to reduce the risks or the impact of data that does not seem to be correct or rational, respectively the impact of the processing component that generates the data that does not seem to be correct or rational, or fraudulent data, wherein the impact of such data in safety-critical features can have immediate real-world impact. For example, when the data provenance of a given machine-learning label is known, a scoring model can be applied to it that calculates the risks of consuming this data label for system central or responsible decision making. A safety-critical action can for example be the issuance of a warning notice to a user, for example a driver of a vehicle. However, the safety critical action can also comprise discarding the instruction generated by the data processing chain or even terminating the data processing chain.

Thus, the method can have an impact on a process outside of the data processing chain, and, in particular, corresponding actions can be taken if the integrity of the data processing chain is low, whereby the quality of the generated data can be ensured and safety requirements can be met. Therein, it can be differentiated between an authenticity verification, for example verification that the result data has been generated by a processing component and which processing component has generated the result data, and a veracity verification, for example verification of the veracity of data provided by external data sources, wherein the veracity verification can be based on a combination of trust, provenance and reputation of the corresponding external data source.

In one example, the step of performing a safety-relevant action can further comprise the steps of determining which one of the plurality of processing components has low integrity based on the transmitted information about the globally unique identifier assigned to the processing component and the source data, and demoting or excluding the result data generated by a processing component that has low integrity.

Here, that a processing component has low integrity means that the integrity of the processing component is not ensured or that there seem to be some risks in transforming data by the processing component, or that result data generated by the processing component does not match result data that would be expected based on a corresponding validation algorithm, wherein the generated result data also matches the expected result data if it is within a confidence interval around the expected data. Further, that the data is demoted means that a lower weight is assigned to the corresponding processing component, and, in particular, to the result data generated by the corresponding processing component in a correspondingly weighted system. Further, that result data of a processing component that does not generate expected result data is excluded means that the corresponding result data is forgotten, respectively discarded.

Therein, as a mechanism for establishing secure data provenance in real time is provided, wherein the data provenance can then be used to ensure the validity of source data inputted into a processing component and also to ensure the accuracy of the data outputted by a processing component. Therefore, misuse and manipulation can effectively be detected and avoided. A corresponding safety-relevant action can be focused on the particular processing component that has low integrity.

The method may further comprise the step of updating the globally unique identifier assigned to a processing component when the processing component is updated. Thereby, it can be ensured that it can be understood which exact digital entity or algorithm has carried out each transformation on the data and when, and therefore, the provenance of the data is made traceable and transparent, even if one or more processing components are updated. Thus, the traceability of the data can even further be improved.

Further, the information about the globally unique identifier assigned to the processing component and the source data can be transmitted as part of metadata transmitted from the processing component to the data manager, wherein the metadata is signed by the globally unique identifier assigned to the processing component. Metadata is structured data which contains information from a resource. With metadata the resource is easier to find as they contain general information, for example a description about the resource. Data transparency can be achieved by enriching the meta information of the data itself, wherein this is done right where the creation or transformation of the data takes place. Further, that the metadata is signed has the advantage that the metadata can be verified and that it can be reconstructed which entity has signed the metadata. It can for example be made transparent why data is demoted or excluded.

According to another example of the present subject matter, an electronic control unit is provided, wherein the electronic control unit comprises a memory in which a globally unique identifier assigned to the electronic control unit is stored, a receiver which is configured to receive source data, a processor which is configured to generate result data from the source data, and a transmitter which is configured to transmit the result data to a data manager, wherein the transmitter is further configured to also transmit information about the globally unique identifier assigned to the electronic control unit and the source data to the data manager.

Here, an electronic control unit is an embedded system, for example in automotive electronics, that controls one or more of the electrical systems or subsystems in a vehicle.

Thus, an electronic control unit is provided, with which the provenance of source data inputted in the electronic control unit s well as the result data generated by the electronic control unit is made traceable, respectively transparent and can be understood. A mechanism for establishing secure data provenance in real time at the hardware level is provided, wherein it is for example indicated that the result data has been generated by the electronic control unit. This data provenance can then be used to ensure the validity of source data inputted into an electronic control unit and to ensure the accuracy of the data outputted by the electronic control unit, and for the detection and avoidance of misuse and manipulation. Therein, the information about a globally unique identifier assigned to the electronic control unit and about the source data is preferably encrypted.

Therein, the electronic control unit can comprise an updating device which is configured to update the electronic control unit, wherein the updating device is further configured to also update the globally unique identifier assigned to the electronic control unit when the electronic control unit is updated. Thereby, it can be ensured that the provenance of the data inputted into the electronic control unit and outputted by the electronic control unit is made traceable and transparent, even if the electronic control unit is updated. Thus, the traceability of the data can even further be improved.

Further, the transmitter can be configured to transmit the information about the globally unique identifier assigned to the electronic control unit and the source data as part of metadata transmitted from the electronic control unit to the data manager, wherein the metadata is signed by the globally unique identifier assigned to the electronic control unit. With metadata the electronic control unit is easier to find as they contain general information, for example a description about the resource. Data transparency can be achieved by enriching the meta information of the data itself, wherein this is done right where the creation or transformation of the data takes place. Further, that the metadata is signed has the advantage that the metadata can be verified and that it can be reconstructed which entity has signed the metadata. In particular, it can for example be made transparent why data is demoted or excluded.

According to still another example of the present subject matter, a vehicle is provided which comprises one or more electronic control units as described above.

Thus, a vehicle is provided, with which the provenance of source data inputted in an electronic control unit of the vehicle and of result data outputted by an electronic control unit of the vehicle is made traceable, respectively transparent and can be understood. A mechanism for establishing secure data provenance in real time at the hardware level is provided, wherein it is indicated which entity, respectively electronic control unit has generated the result data. This data provenance can then be used to ensure the validity of source data inputted into an electronic control unit and also to ensure the accuracy of the data outputted by the electronic control unit, and for the detection and avoidance of misuse and manipulation. Therein, the information about a globally unique identifier assigned to the processing component and about the source data is preferably encrypted.

That a globally unique identifier is assigned to each of the one or more electronic control units has the advantage that also data provided by external data sources, which can also be regarded as a processing component within the corresponding data processing chain, and therefore, be regarded as an electronic control unit, can, usually after a corresponding trust verification, be provided and processed within the vehicle, respectively a corresponding data processing chain, wherein also the provenance of the externally provided data is transparent and can be understood.

Therein, the vehicle can further comprise a validating device which is configured to validate integrity of the result data based on the transmitted information about the globally unique identifiers assigned to the one or more electronic control units and the source data, and an electronic control unit which is configured to perform a safety-relevant action if it is determined that the result data has a low integrity.

Here, that the result data has a low integrity means that there seem to be some risks in processing the data, or that the result data does not seem to be correct or rational, based on a given source data.

Thus, the vehicle is configured to take safety-relevant actions if the integrity of the generated result data is low, whereby the quality of the generated data can be ensured, and safety requirements can be met. Therein, the validating device can be configured to perform an authenticity verification, for example verification that the result data has been generated by an electronic control unit and which electronic control unit has generated the result data, and to perform a veracity verification, for example verification of the veracity of data provided by external data sources, wherein the veracity verification can be based on a combination of trust, provenance and reputation of the corresponding external data source.

Therein, in one example, the validating device can be configured to determine which electronic control unit of the vehicle has low integrity based on the transmitted information about the globally unique identifier assigned to the first processing component and the source data, wherein the electronic control unit can be configured to demote or exclude the result data generated by an electronic control unit that has low integrity. Therein, as a mechanism for establishing secure data provenance in real time is provided, wherein the data provenance can then be used to ensure the validity of source data inputted into an electronic control unit and also to ensure the accuracy of the data outputted by an electronic control unit, it can be understood which of the electronic control units of the vehicle has low integrity. Therefore, misuse and manipulation can effectively be detected and avoided. A corresponding safety-relevant action can be focused on the particular electronic control unit that has low integrity, wherein the whole data processing chain does not have to be terminated anymore.

According to still a further example of the present subject matter, a data processing chain is provided, wherein the data processing chain comprises a plurality of processing components, wherein each of the plurality of processing components is configured to process source data to generate result data, wherein a globally unique data identifier is assigned to each of the plurality of processing components, and wherein each of the plurality of processing components is configured to, in response to processing source data, transmit the corresponding result data to a data manager, wherein transmitting the corresponding result data to the data manager comprises transmitting information about a globally unique identifier assigned to the processing component and the source data to the data manager.

Thus, a data processing chain is provided, with which the provenance of source data inputted in a processing component of the data processing chain and result data generated by a processing component of the data processing chain is made transparent and can be understood. A mechanism for establishing secure data provenance in real time at the hardware level is provided, wherein it is indicated which processing component has generated the result data. The data provenance can then be used to ensure the validity of source data inputted into a processing component and also to ensure the accuracy of the data outputted by a processing component, and for the detection and avoidance of misuse and manipulation. Therein, the information about a globally unique identifier assigned to the processing component and about the source data is preferably encrypted.

That a globally unique identifier is assigned to each processing component has the advantage that also data provided by external data sources can, usually after a corresponding trust verification, be provided and processed within the data processing chain, wherein also the provenance of the externally provided data is transparent and can be understood.

The data processing chain can further comprise a validating device which is configured to validate integrity of the data processing chain based on the transmitted information about the unique identifier assigned to the processing component and the source data, and an electronic control unit which is configured to perform a safety-relevant action if it is determined that the data processing chain has a low integrity.

Here, that the data processing chain has a low integrity means that there seem to be some risks in processing the data or that the instruction generated by the data processing chain, or that the result data generated by one or more processing components does not seem to be correct or rational, based on a given source data.

Thus, the data processing chain is configured to take safety-relevant actions if the integrity of the generated result data is low, whereby the quality of the generated data can be ensured, and safety requirements can be met. Therein, the validating device can be configured to perform an authenticity verification, for example verification that the result data has been generated by a processing component and which processing component has generated the result data, and to perform a veracity verification, for example verification of the veracity of data provided by external data sources, wherein the veracity verification can be based on a combination of trust, provenance and reputation of the corresponding external data source.

Therein, the validating device can be configured to determine which one of the plurality of processing components has low integrity based on the transmitted information about the globally unique identifier assigned to the processing component and the source data, wherein the electronic control unit can be configured to demote or exclude the result data generated by a processing component that has low integrity. Here, that a processing component has low integrity means that the integrity of the processing component is not ensured or that there seem to be some risks in transforming data by the processing component, or that result data generated by the processing component does not match result data that would be expected based on a corresponding validation algorithm, wherein the generated result data also matches the expected result data if it is within a confidence interval around the expected data. Therein, as a mechanism for establishing secure data provenance in real time is provided, wherein the data provenance can then be used to ensure the validity of source data inputted into a processing component and also to ensure the accuracy of the data outputted by a processing component, it can be understood which of the processing components has low integrity. Therefore, misuse and manipulation can effectively be detected and avoided. A corresponding safety-relevant action can be focused on the particular processing component that has low integrity, wherein the whole data processing chain does not have to be terminated anymore.

The data processing chain can further comprise at least one updating device which is configured to update the plurality of processing components, wherein the at least one updating device is further configured to also update the globally unique identifier assigned to a processing component when the corresponding processing component is updated. Thereby, it can be ensured that the provenance of the data inputted into a processing component and outputted by the processing component is made traceable and transparent, even if the processing component is updated. Thus, the traceability of the data can even further be improved.

Further, each of the plurality of processing components can be configured to transmit the information about the globally unique identifier assigned to the processing component and the source data as part of metadata transmitted from the processing component to the data manager, wherein the metadata is signed by the globally unique identifier assigned to the processing component. With metadata the processing component is easier to find as they contain general information, for example a description about the resource. Data transparency can be achieved by enriching the meta information of the data itself, wherein this is done right where the creation or transformation of the data takes place. Further, that the metadata is signed has the advantage that the metadata can be verified and that it can be reconstructed which entity has signed the metadata. In particular, it can be made transparent why data is demoted or excluded.

Examples of the present subject matter will now be described with reference to the drawings.

### BRIEF DESCRIPTION OF THE DRAWINGS

FIG. 1 illustrates an automotive data processing chain;

FIG. 2 illustrates a data processing chain according to examples of the present subject matter;

FIG. 3 illustrates a flow chart of a method for ensuring transparency of data provenance in a data processing chain according to examples of the present subject matter;

FIG. 4 illustrates an implementation of a method for ensuring transparency of data provenance in a data processing chain according to one example of the present subject matter.

### DETAILED DESCRIPTION

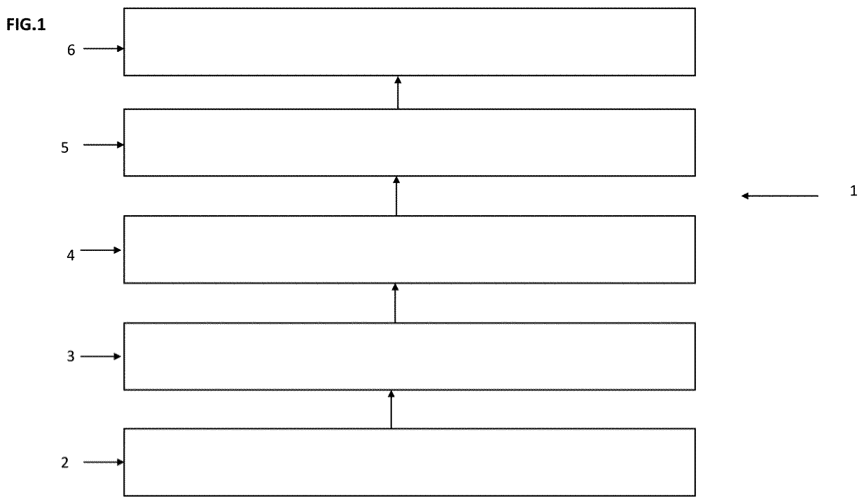

FIG. 1 illustrates a typical high-level data architecture in a vehicle environment. Therein, a data processing flow starts with a data producer 2, typically an electronic control unit, which transports a signal over a system bus. The signal is received and edge-processed within the vehicle by a data collector 3, typically another electronic control unit. The first pre-processing of the signal for example adding meta data information or doing some pre-calculation, will be done here, before it will be transported to a further electronic control unit, a digital representation 4, which defines the incoming data of the physical vehicle through a digital model, and offers it to applications as a digital shadow or even a digital twin of the vehicle. From there, an optional data fusion with data from external data sources 5 is possible, wherein the data is then consumed by data processors 6, respectively electronic control units, which in turn create new data of interest for example for an external data consumer.

Big data processing and analytics are a more and more important aspect of modern computing. Organizations are relying on insights derived from big data to aid in decision making, identify cost reduction opportunities, etc. Therein, based on the growing use of data producing and/or Internet of Things (IoT) devices, there is a trend toward processing open data.

For example, with almost every new vehicle being connected, the importance of vehicle data is growing rapidly. Therein, many mobility applications rely on the fusion of data coming from heterogeneous data sources, for example vehicles and data transmitted to the vehicles from outside of the vehicle, for example smart-city data, or process data generated by systems out of their control. This external data determines much about the behavior of the relying applications. For example, it impacts the reliability, security and overall quality of the data inputted into an application and ultimately of the application itself.

The secure traceability of data handling along an entire processing chain, which passes through various distinct systems, is, however, critical for the detection and avoidance of misuse and manipulation. Therefore, there is a need for ensuring the validity of source data inputted into such an application and also to ensure the accuracy of the data outputted by the application. Upcoming regulations around cyber-security underline this importance.

According to the present subject matter, this object is solved by identifying entities which create data or perform data transformation in a data processing chain 1, and the introduction of data structures for representing distributed data.

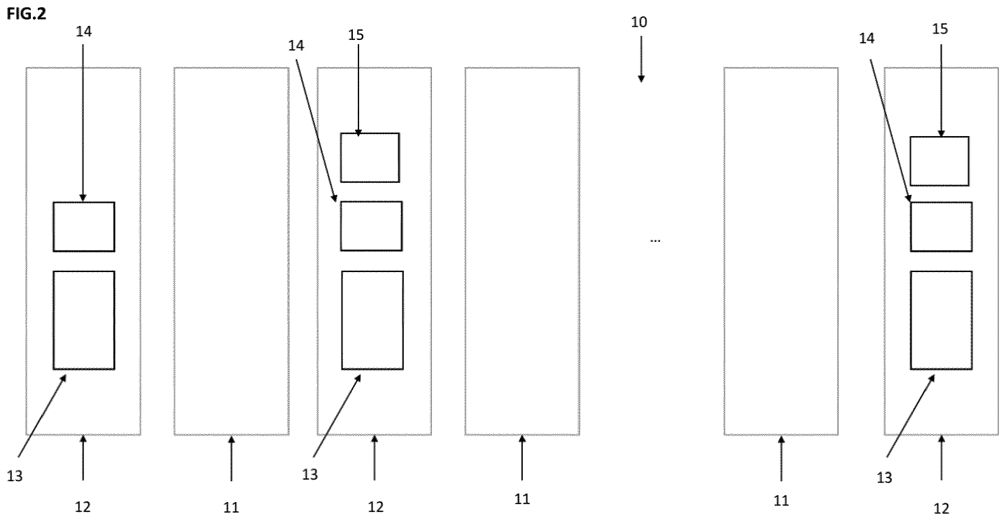

FIG. 2 illustrates a data processing chain 10 according to examples of the present subject matter.

As shown in FIG. 2, the data processing chain 10 comprises a plurality of processing components 11, wherein each of the plurality of processing components 11 is configured to process source data to generate result data, and wherein the source data is collected by the processing component 11 or received from one or more other processing components 11, respectively one or more data managers 12.

Therein, the processing components can be the same as in the automotive data processing chain shown in FIG. 1, a data producer, a data collector, a digital representation, external data sources, and data processors. For example, the data processing chain can be configured to detect situations of dangerous driving on an incoming stream of vehicle data and to classify the maneuver, in particular whether to turn left, to turn right, to accelerate, etc. Therein, the data processing chain predicts for every timestamp the result based on the previous ten frames or data points, wherein the input data consists of categorical data, for example a current gear, or whether a vehicle brake is pressed, and continuous signals, for example a current position of the vehicle, lateral and longitudinal acceleration, etc.

However, the present subject matter is also applicable to other applications, as almost every business must know the origin and risks of data from different sources before using them. Generally, a data processing chain can be a sequence of processes that generate an instruction for example an instruction for an electronic component, based on a given source data, wherein the data is successively processed by the sequence of processes. A data processing chain consists of a start process, individual application processes and a collection process. Further, the sequence of processes is scheduled to wait in the background for an event, wherein some of these processes trigger a separate event that can, in turn, start other processes.

According to the examples of FIG. 2, a globally unique data identifier is assigned to each of the plurality of processing components 11, wherein each of the plurality of processing components 11 is configured to, in response to processing source data, transmit the corresponding result data 13 to a data manager 12, wherein transmitting the corresponding result data 13 to a data manager 12 comprises transmitting information about the globally unique identifier assigned to the processing component and information about the source data 14.

Therein, each data manager 12 can be configured to store the information about a globally unique identifier assigned to the processing component and information about the source data 14, and to distribute the result data as source data to other processing components 11. Such a data manager can for example be integrated in a BE-system, respectively an apparatus implementing a digital twin of a twinned physical system, for example a vehicle, or a further processing component that is configured to subsequently process the result data. Further, according to the examples of FIG. 2, a separate data manager is assigned to each processing component. This should, however, merely be understood as an example and a data manager can also be assigned to more than one processing component.

Thus, according to the examples of FIG. 2, a data processing chain 10 is provided, with which the provenance of source data inputted in a processing component 11 of the data processing chain 10 and of result data generated by a processing component 11 of the data processing chain 10 is made transparent and can be understood. A mechanism for establishing secure data provenance in real time at the hardware level is provided, wherein it is indicated which processing component 11 has generated the result data. The data provenance can then be used to ensure the validity of source data inputted into a processing component 11 and also to ensure the accuracy of the data outputted by a processing component 11, and, in particular, for the detection and avoidance of misuse and manipulation.

That a globally unique identifier is assigned to each processing component 11 has the advantage that also data provided by external data sources, which can also be regarded as a processing component, can, usually after a corresponding trust verification, be provided and processed within the data processing chain 10, wherein also the provenance of the externally provided data is transparent and can be understood.

According to the examples of FIG. 2, decentralized identifiers are used as globally unique identifiers. In particular, the decentralized identifier standard is adopted as an open, interoperable addressing scheme and to establish mechanisms for resolving decentralized identifiers across multiple centralized and/or decentralized systems.

Decentralized identifiers were originally designed to function as identifiers for individual people but can readily be extended to any entity or resource. They are derived from public/private key pairs, registered in an immutable registry for discovery purposes.

Each domain or namespace for decentralized identifiers further corresponds to a method of encoding and decoding, making decentralized identifiers resolvable like domain names relative to a method-specific but interoperable resolution infrastructure.

According to the examples of FIG. 2, each processing component 11 is configured to transmit the information about the globally unique identifier assigned to the processing component 11 and the source data 14 as part of metadata transmitted from the processing component 11 to the corresponding data manager 12, wherein the metadata is signed by the globally unique identifier assigned to the corresponding processing component 11. Therein, each data creation or data transformation appends a new link in a chain of linked and signed versions in such a way, that each data point can be updated, wherein each updated data point is both, signed by the transformer and linked back to its previous state. Therefore, as shown in FIG. 2, beginning with the second data manager 12 also information about globally unique identifiers assigned to preceding processing components and about the source data inputted into these preceding processing components 15 is stored.

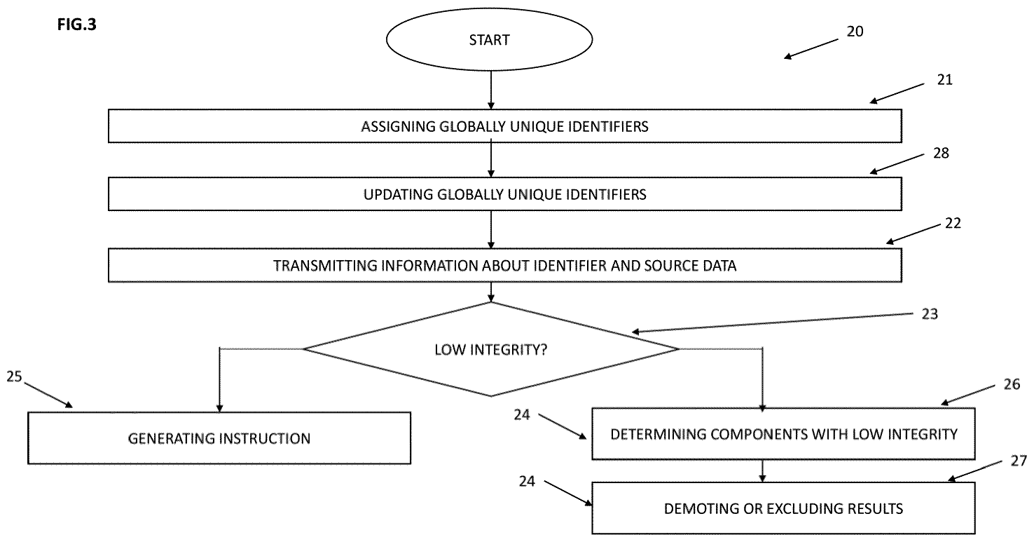

FIG. 3 illustrates a flow chart of a method 20 for ensuring transparency of data provenance in a data processing chain according to examples of the present subject matter.

In particular, FIG. 3 illustrates a flow chart of a method 20 for ensuring transparency of data provenance in a data processing chain, wherein the data processing chain comprises a plurality of processing components, wherein each of the plurality of processing components is configured to process source data to generate result data.

Therein, as shown in FIG. 3, the method 20 comprises the steps of assigning a globally unique data identifier to each of the plurality of processing components 21, and in response to a processing component of the plurality of processing components processing source data, transmitting the corresponding result data to a data manager, wherein transmitting the corresponding result data to a data manager comprises transmitting information about a globally unique identifier assigned to the processing component and about the source data to the data manager 22.

According to the examples of FIG. 3, the result data is further transmitted to the data manager in association with a process identifier, respectively an identifier assigned to a process performed by the processing component, wherein the process identifier can for example be generated by a hash ID generator or can also be a decentralized identifier, whereby the result data can also be linked to the corresponding process.

FIG. 3 further shows the step of validating integrity of the data processing chain based on the transmitted information about the globally unique identifier assigned to the processing component and the source data 23, wherein, if it is determined that the data processing chain has a low integrity, a safety-relevant action 24 is performed, and wherein, if it is determined that the data processing chain does not have a low integrity, an instruction is generated by the data processing chain as usual 25. Therein, according to the examples of FIG. 3, an authenticity verification, for example verification that the result data has been generated by a processing component and which processing component has generated the result data, and a veracity verification, for example verification of the veracity of data provided by external data sources, can be performed, wherein the veracity verification can be based on a combination of trust, provenance and reputation of the corresponding external data source.

In particular, when the data provenance of a given dangerous driving scenario, respectively a dangerous driving machine learning label is known, a scoring model can be applied to it that calculates the risks of consuming this data label for system control or responsible decision making.

Here, that the data processing chain has a low integrity means that there seem to be some risks in processing the data or that the instruction generated by the data processing chain, or that the result data generated by one or more processing components does not seem to be correct or rational, based on a given source data.

According to the examples of FIG. 3, the step of performing a safety-relevant action 24 further comprises the steps of determining which one of the plurality of processing components has low integrity based on the transmitted information about the globally unique identifier assigned to the processing component and the source data 26, and demoting or excluding the result data generated by a processing component that has low integrity 27.

Here, that a processing component has low integrity means that the integrity of the processing component is not ensured or that there seem to be some risks in transforming data by the processing component, or that the result data generated by the processing component does not match result data that would be expected based on a corresponding validation algorithm, wherein the generate result data also matches the expected result data if it is within a confidence interval around the expected data.

According to the examples of FIG. 3, the method 20 further comprises the step of updating the globally unique identifier assigned to a processing component when the processing component is updated 28.

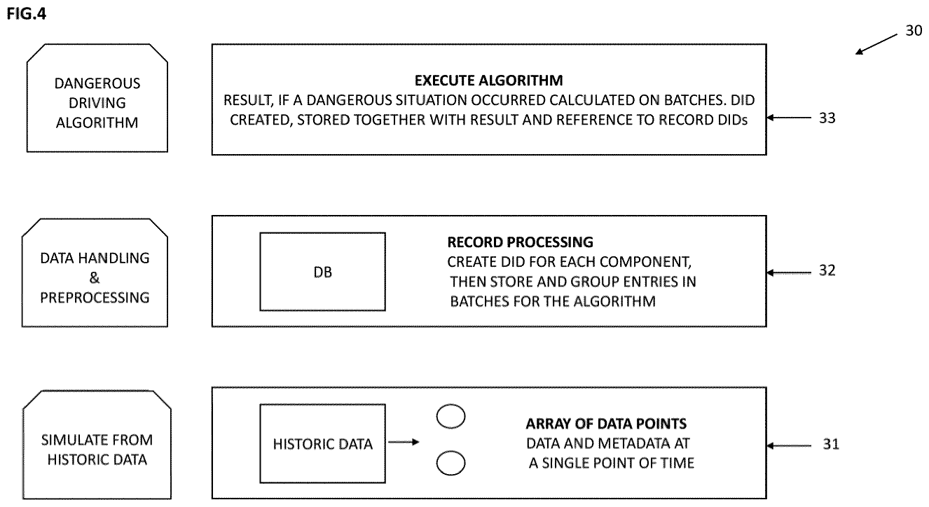

FIG. 4 illustrates an implementation of a method 30 for ensuring transparency of data provenance in a data processing chain according to one example of the present subject matter.

In particular, FIG. 4 relates to the implementation of a verifiable data chain for a supervised learning scenario with an algorithm detecting dangerous driving scenarios.

According to the example of FIG. 4, a data processing chain is configured to detect situations of dangerous driving on an incoming stream of vehicle data and to classify the maneuver, in particular whether to turn left, to turn right, to accelerate, etc. Therein, as shown, the data processing chain predicts for every timestamp the result based on the previous ten frames or data points, wherein the input data consists of categorical data, for example a current gear, or whether a vehicle brake is pressed, and continuous signals, for example a current position of the vehicle, lateral and longitudinal acceleration etc. 31. This historical data set contains, for each point in time, an array of data points which are the relevant features for the model.

However, although an implementation in a dangerous driving scenario is shown in FIG. 4, this should merely be understood as an example and the method is applicable in different implementations, for example in the field of insurance business, too.

As also shown in FIG. 4, each array is sent to a component, responsible for the data handling and processing, wherein a globally unique identifier is created for each component that performs data handling and processing, and wherein for every data point distributed automotive data is created. Then, the distributed automotive data including the information about a globally unique identifier assigned to a component and about the data processed by this component is stored 32.

As further shown in FIG. 4, the outcome of the model, respectively the classification of a situation as dangerous, the type of maneuver and possibly the confidence thereof, is then stored as another distributed automotive data, which refers to the globally unique identifiers, which are included in the distributed automotive data output of the final result 33.

Thereby, the usually cryptographic data structure provides instruments for end-to-end verifiability that enables to prove the integrity of the data chain, identify all components involved in the creation of the specific machine learning label, and to request, in turn, life-cycle credentials from these components to feed a scoring model for the respective machine learning label.

A technical feature or several technical features which has/have been disclosed with respect to a singular or several examples disclosed herein before, may be present also in another example, except it is/they are specified not to be present or it is impossible for it/them to be present for technical reasons.

### LIST OF REFERENCE SIGNS

1 automotive data processing chain
2 data producer
3 data collector
4 digital representation
5 external data source
6 data processor
10 data processing chain
11 processing component
12 data manager
13 result data
14 information
15 information
20 method
21 step
22 step
23 step
24 step
25 step
26 step
27 step
28 step
30 method
31 step
32 step
33 step

1.-15. (canceled)

16. A method for ensuring transparency of data provenance in a data processing chain, wherein the data processing chain comprises a plurality of processing components and each of the plurality of processing components is configured to process source data to generate result data, the method comprising:
assigning a globally unique data identifier to each of the plurality of processing components; and
in response to a processing component of the plurality of processing components processing source data, transmitting result data to a data manager, wherein the result data comprises:
(1) information about a globally unique identifier assigned to the processing component, and
(2) information about the source data.

17. The method according to claim 16, further comprising:
validating integrity of the data processing chain based on the transmitted information about the globally unique identifier assigned to a first processing component of the plurality of processing components and the source data.

18. The method according to claim 17, further comprising:
determining that the data processing chain has a low integrity; and
performing a safety-relevant action in response.

19. The method according to claim 18, wherein the step of performing a safety-relevant action further comprises:
determining which one of the plurality of processing components has low integrity based on the transmitted information about the globally unique identifier assigned to the processing component and the source data; and
demoting or excluding the result data generated by a processing component that has low integrity.

20. The method according to claim 16, wherein the method further comprises:
updating the globally unique identifier assigned to a processing component when the processing component is updated.

21. The method according to claim 16, wherein
the information about the globally unique identifier assigned to the processing component and the source data is transmitted as part of metadata transmitted from the processing component to the data manager, and
the metadata is signed by the globally unique identifier assigned to the processing component.

22. An electronic control unit, comprising:
a memory in which a globally unique identifier assigned to the electronic control unit is stored;
a receiver configured to receive source data;
a processor configured to generate result data from the source data; and
a transmitter which is configured to transmit the result data to a data manager, wherein
the transmitter is further configured to also transmit information about the globally unique identifier assigned to the electronic control unit and the source data to the data manager.

23. The electronic control unit according to claim 22, further comprising:
an updating device configured to update the electronic control unit, wherein
the updating device is further configured to also update the globally unique identifier assigned to the electronic control unit when the electronic control unit is updated.

24. The electronic control unit according to claim 22, wherein
the transmitter is configured to transmit the information about the globally unique identifier assigned to the electronic control unit and the source data as part of metadata transmitted from the electronic control unit to the data manager, wherein
the metadata is signed by the globally unique identifier assigned to the electronic control unit.

25. A vehicle comprising:
one or more electronic control units according to claim 22.

26. The vehicle according to claim 25, further comprising:
a validating device configured to validate integrity of the result data based on the transmitted information about the globally unique identifiers assigned to the one or more electronic control units and the source data, and
an electronic control unit configured to perform a safety-relevant action in response to a determination that the result data has a low integrity.

27. A data processing chain, comprising:
a plurality of processing components, wherein
each of the plurality of processing components is configured to process source data to generate result data,
a globally unique data identifier is assigned to each of the plurality of processing components, and
each of the plurality of processing components is configured to, in response to processing source data, transmit corresponding result data to a data manager, wherein the result data comprises:
(1) information about a globally unique identifier assigned to the transmitting processing component, and
(2) information about the source data.

28. The data processing chain according to claim 27, further comprising:
a validating device configured to validate integrity of the data processing chain based on the transmitted information about the globally unique identifier assigned to the processing component and the source data, and
an electronic control unit configured to perform a safety-relevant action in response to a determination that the data processing chain has a low integrity.

29. The data processing chain according to claim 28, wherein
the validating device is further configured to determine which one of the plurality of processing components has low integrity based on the transmitted information about the globally unique identifier assigned to the processing component and the source data, and
the electronic control unit is further configured to demote or exclude the result data generated by a processing component that has low integrity.

30. The data processing chain according to claim 27, further comprising:
at least one updating device configured to:
update the plurality of processing components,
update the globally unique identifier assigned to a processing component when the corresponding processing component is updated.

31. The data processing chain according to claim 27, wherein
each of the plurality of processing components is configured to transmit the information about the globally unique identifier assigned to the processing component and the source data as part of metadata transmitted from the transmitting processing component to the data manager, and
the metadata is signed by the globally unique identifier assigned to the transmitting processing component.
